(19) United States
(12) Patent Application Publication
(10) Pub. No.: US 2011/0032143 A1
(43) Pub. Date: Feb. 10, 2011

(54) Fixed User Terminal for Inclined Orbit Satellite Operation

(76) Inventors: Yulan Sun, Canoga Park, CA (US); Donald D. C. Chang, Thousand Oaks, CA (US); Frank Lu, Reseda, CA (US)

Correspondence Address: Spatial Digital Systems, 9428 Eton Ave Suite G, Chatsworth, CA, 91311, US

(21) Appl. No.: 12/848,960

(22) Filed: Aug. 2, 2010

Related U.S. Application Data
(60) Provisional application No. 61/273,502, filed on Aug. 5, 2009.

(51) Int. Cl. H04B 7/185

(52) U.S. Cl. 342/354

(57) ABSTRACT

An advanced multiple-beam fixed ground terminal is achieved that is capable of simultaneously tracking multiple inclined orbit satellites, increasing and suppressing gain in multiple directions. The fixed user terminal equipped with digital beam-forming and null-forming technique can track and identify signals from multiple inclined orbit satellites at the same time. This technique enables a geostationary satellite drift to an inclined orbit without losing communication with ground terminals which not only increase the life span of an inclined orbit satellite, but also relieve the scarcity of geo-stationary orbit. In extreme cases, satellite can be placed in the same slot which further enhanced the usage of geosynchronous orbits. Another present invention is to from double nulls whose null width is much wider than a single null. A wider null increases the system robustness to frequency drift and change of signal direction, thus in turn reduce the system's complexity by lowering update beam wave vectors. To use the same beam wave vector on wider frequency spans, an FIR filter need to be designed according to system requirements.

### RELATED APPLICATION DATA

This application claims the benefit, pursuant to 35 U.S.C. §119(e), of U.S. provisional application Ser. No. 61/273,502, filed Aug. 5, 2009.

### BACKGROUND OF THE INVENTION

1. Field of the Invention

The present invention relates to architectures and designs of fixed user terminal (FUT) for inclined orbit satellite operation. In particular, the invention relates to the design of multiple-beam antennas using digital beam forming techniques to enable receiving signals from an inclined orbit satellite and eliminating interference from other inclined orbit satellites at the same slot.

2. Description of Related Art

A geostationary orbit (GEO) is 37,000 km (22,300 miles) above the Earth's equator in which a satellite appears motionless from a fixed observation point on the earth. Due to the influence of the sun and the moon, a geostationary orbit satellite gradually drifts several degrees north or south from the horizontal defined by the equator. Substantial rocket fuel is used to counteract the gravitational forces and keep the satellite in the geostationary orbit. However, when the keeping fuel depletes, a geostationary orbit satellite will have its inclination increase 0.8 degree every year until it reaches the maximum inclination at about 6 degree and then, the satellite will start to move back. The inclination weakens satellite signals and eventually causes the disconnection of communications between the satellite and ground terminals. Usually, a satellite dies due to the lack of Hydrazine fuel, although its electronics are still fully functional. Thus, the practical lifespan of geostationary orbit satellites is based on the amount of fuel left on the satellite.

Because the electronics onboard the satellites are still intact, they are still technically usable. The inclination drift does weaken satellite signals, but because the number of GEO orbital slots is limited, there is a need to either prolong the lifespan of existing satellites or stack multiple satellites within the same orbital slots. However, seeing as how the issue of satellite lifespan is constrained by fuel, it is necessary to focus on what the ground stations can do to mitigate this problem. Additionally, there are several issues with stacking satellites within the same orbital slot. The satellites may interfere with each other, causing unwanted phase shifts, interference, or reception by ground stations of the wrong signals.

One of the solutions that is proposed to extend the lifespan of a satellite when inclined is to use a fixed ground terminal equipped with digital beam forming technology to track the satellite's movement which can effectively solve the problem of communication loss. Additionally, this effectively extends the lifespan of satellites well past their expected end-of-use date.

Furthermore, by utilizing the multiple-beam forming technique which enhances gain in multiple directions, we are capable of tracking several inclined orbit satellites simultaneously. Meanwhile, the technology of forming multiple-nulls which suppress the gain from several directions enables us to eliminate the interference from unwanted nearby sources. Therefore, we can place multiple satellites in one or several inclined orbits, track signal from desired satellites and eliminate unwanted ones by using multiple beam forming and multiple null forming respectively. Thus the scarcity of geo-stationary orbits can be greatly relieved. In extreme scenarios, we can place multiple satellites in the same vertical slot on different inclined orbits which will further improve the usage of geosynchronous orbits.

The following references are presented for further background information:
J. Bousquet, P. Menard, “Antenna system, in particular for pointing at non-geostationary satellites,” U.S. Pat. No. 6,218,999, Apr. 17, 2001;
D. Tits, Drouc sur Drouette (F R), K. Lotfy, Paris (F R), “Antenna system for receiving signals that are transmitted by geostationary satellite,” U.S. Pat. No. 6,504,504, Jan. 7, 2003;
D. Chang, “Retro-directive ground-terminal antenna for communication with geostationary satellites in slightly inclined orbits,” U.S. patent Ser. No. 12/122,585, Nov. 27, 2008.

### SUMMARY OF THE INVENTION

An advanced multiple-beam fixed ground terminal that is capable of tracking multiple inclined orbit satellites and simultaneously suppressing gain in the directions of interfering sources is achieved.

An embodiment of a FUT system in accordance with the present invention comprises a reflector and an aperture composed of multiple antenna elements configured as a receiving array. Signals received by each antenna element will be transmitted to a digital beam forming (DBF) processor which adaptively generates and applies appropriate beam wave vectors (BMW) to the signals received from each element of the array to create one or more coherent beams from received signals. A key factor in the performance of the array is the number of antenna elements which determines the degree of freedom of the array. As the number of antenna elements increases, more control over the shaping of the antenna patterns is achieved. The number of separate interfering sources that can be suppressed by pattern shaping is equal to one less than the number of “available” elements (N−1).

An inclined orbit satellite drifts 0.8 degree to the north or south annually. However, since the inclination of an orbit changes very slowly, it can be considered as geosynchronous which means if observed from a fixed point on the earth, it returns to exactly the same place in the sky at the exactly the same time every day. Thus, a series of BWVs can be generated and used repeatedly to track an inclined orbit satellite by forming peaks according to the satellite's movement on a daily basis. Similarly, nulls can also be formed simultaneously to eliminate the interfering signal from other inclined orbit satellites. Therefore, an FUT is capable of tracking desired signals from multiple inclined orbit satellites and simultaneously eliminating interfering noises from other satellites by using the digital beam forming technique. In particular, several satellites can even be placed in the same vertical slot in different incline orbits without interfering with each other which provides an alternative to placing satellites on geostationary orbits which is becoming more and more scare nowadays.

One alternative method to perform one-dimensional limit scan is to substitute the expensive DBF processor with several switches to controls the combination of signals from a plurality of antenna elements. Usually, we can acquire better secondary patterns by combining multiple over-illuminated horns into one focused horn. And we can have more combinations of combined focused horn by using several switches. Although the performance of beam forming achieved by using switches is not as good as those achieved by using adaptive DBF technique and its function is limited, this method provides an economical and easy solution to one dimensional limit scan and tracking.

The double null forming technique is another invention to present which can substantially reduce the complexity of FUT and make it more applicable in tracking signal from desired inclined orbit satellites and suppressing noise from others. The concept of double null forming technique is to form two different nulls in the vicinity of desired direction which in turn has a much wider width than a single null. In the case of observing an inclined orbit satellite from a fixed point on the earth, the satellite moves slowly on a trace in the shape of an “8” every 24 hours. Even though the movement is very slow, an FUT will still have to change its BWVs from time to time when eliminating an interfering signal since the null formed by traditional beam forming techniques is very narrow. However, by utilizing the double null forming technique, we don't need to change a BWV until the interfering satellite moves outside the null which greatly reduces the amount of calculation.

Another merit of double null forming is that it also brings about higher frequency tolerance than a single null. Normally, when the signal frequency increases, the secondary pattern of the signal will shrink towards the zero axis, and vise versa. Therefore, a single null with narrow null width is very vulnerable to frequency change. In contrast, a wider null still performs well in the case of frequency drift only if the null of the secondary pattern still involves interfering satellite. Another alternative method to increase operation bandwidth is letting a BWV pass through an FIR (Finite Impulse Response) filter to meet the specified requirement at certain frequency band. One benefit of using an FIR filter is that a BWV can be used on a very wide frequency span. However, it increases the complexity and cost of the system.

From the foregoing discussion, it should be clear that certain advantages have been achieved for a FUT with the presented digital beam forming technique to communication with an inclined orbit satellites system. Further advantages and applications of the invention will become clear to those skilled in the art by examination of the following detailed description of the preferred embodiment. Reference will be made to the attached sheets of drawing that will first be described briefly.

### BRIEF DESCRIPTION OF THE DRAWINGS

FIG. 1 depicts the structure of a fixed user terminal (FUT) which is composed of a reflector and an antenna array.

FIG. 2 depicts the daily trace line of an inclined orbit satellite observed from different locations on the earth.

FIG. 3 illustrates an example of placing inclined orbit satellites in which satellites are place in the same slot in different inclined orbits.

FIG. 4 illustrates the architecture of an antenna array with horn switching function.

FIG. 5 illustrates the secondary pattern of an antenna array applied with specified BWV to form a peak at 0 degree and form 2 nulls at −2 and 2 degree.

FIG. 6 illustrates a the secondary pattern of an antenna array applied with specified BWV to form a peak at 0 degree and form 2 double nulls at −2 and 2 degree

FIG. 7 depicts a selection scheme of 2 inclined orbit satellites using different BWVs. In this scenario, 2 satellites are located at 0 degree and 2 degrees respectively.

FIG. 8 illustrates the secondary patterns using the same BWV at different frequencies from 19.95 GHz to 20.20 GHz.

### DETAILED DESCRIPTION OF THE PREFERRED EMBODIMENT

The present invention relates to the fields of communications systems and fixed user terminal design, and, in particular, to satellite-to-ground terminal communications and signal transmission methods. More specifically, but without limitation thereto, the present invention provides an advanced multi-beam fixed user terminal transceiver that is capable of tracking and communicating with multiple inclined orbit satellites while simultaneously tracking and eliminating interference signals from the direction of unwanted inclined orbit satellites. In this section, detailed description will be included by using figures and examples, etc.

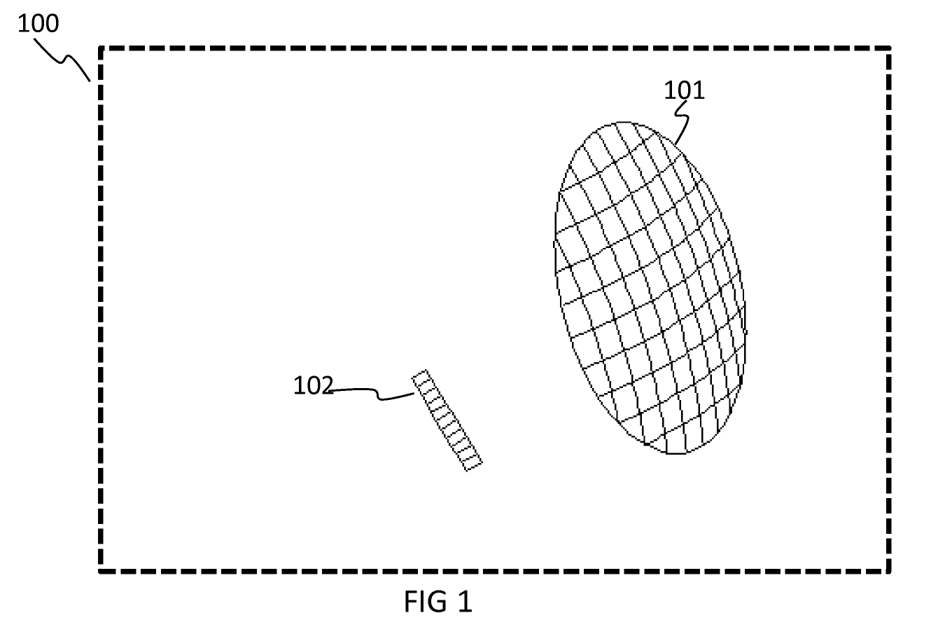

As depicted in FIG. 1, our designed fixed user terminal 100 consists of a reflector 101 and a patch array 102, which composes a single antenna element. More than one antenna element may be used to comprise the fixed user terminal. Each element collects signals independently and then transmits signals to the beam-forming process which apply appropriate beam wave vectors on each signals to form desired beams or nulls.

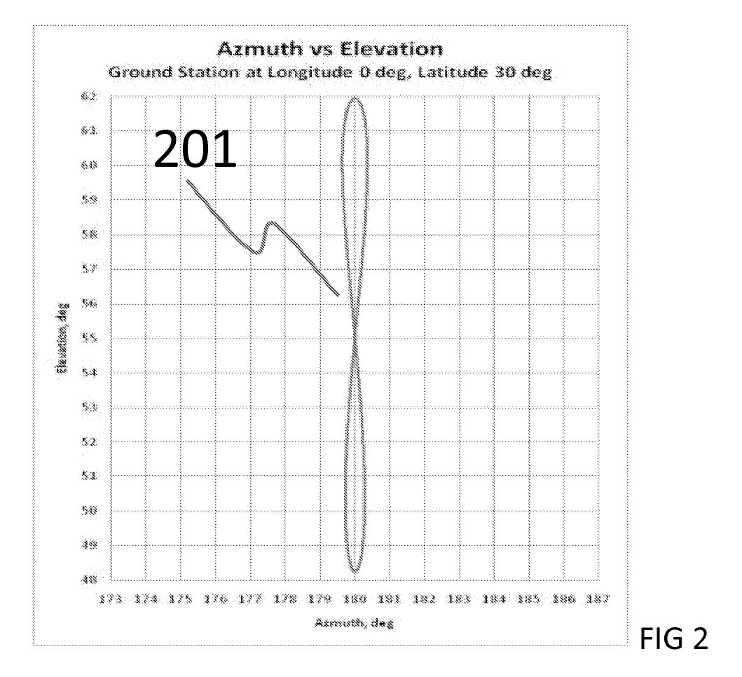

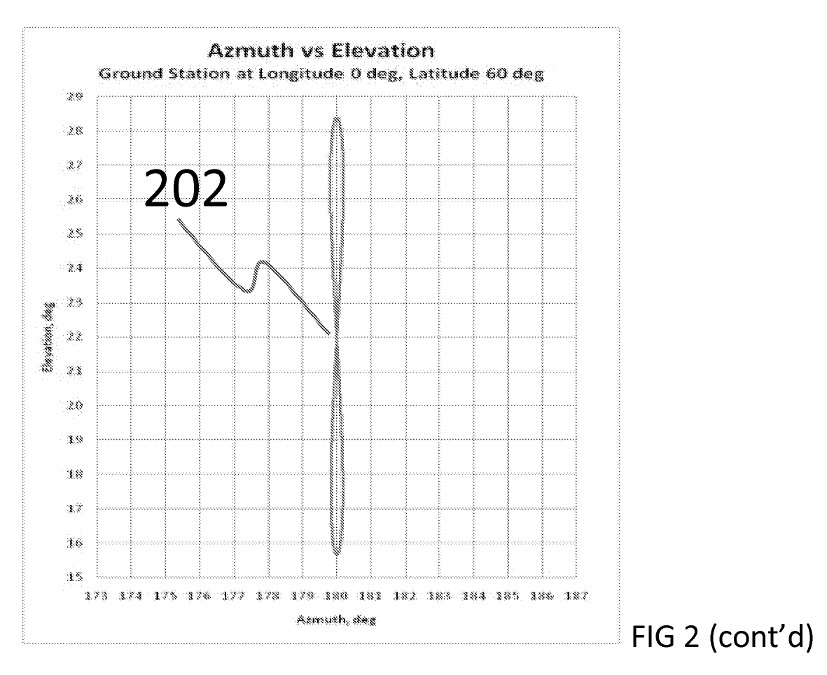

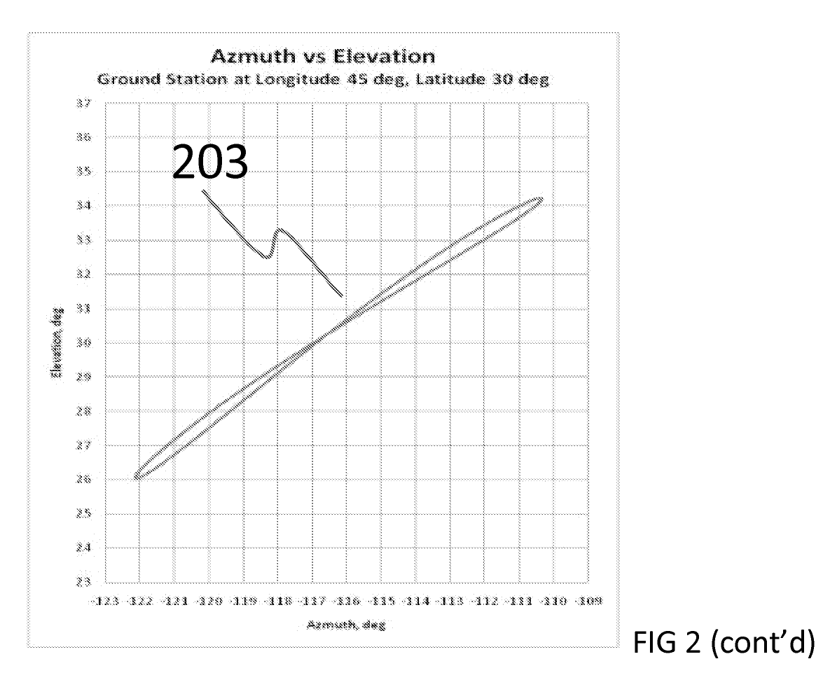

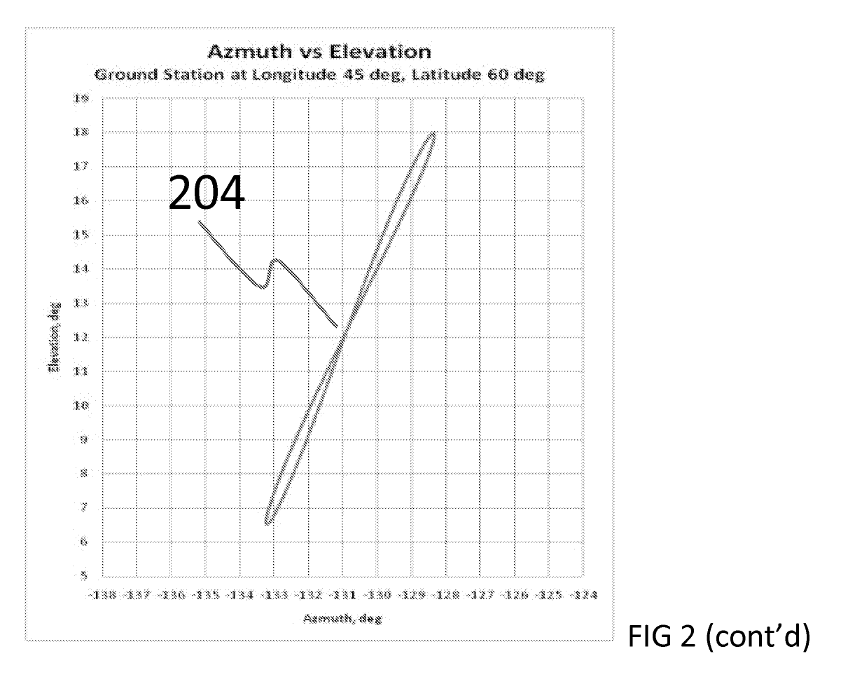

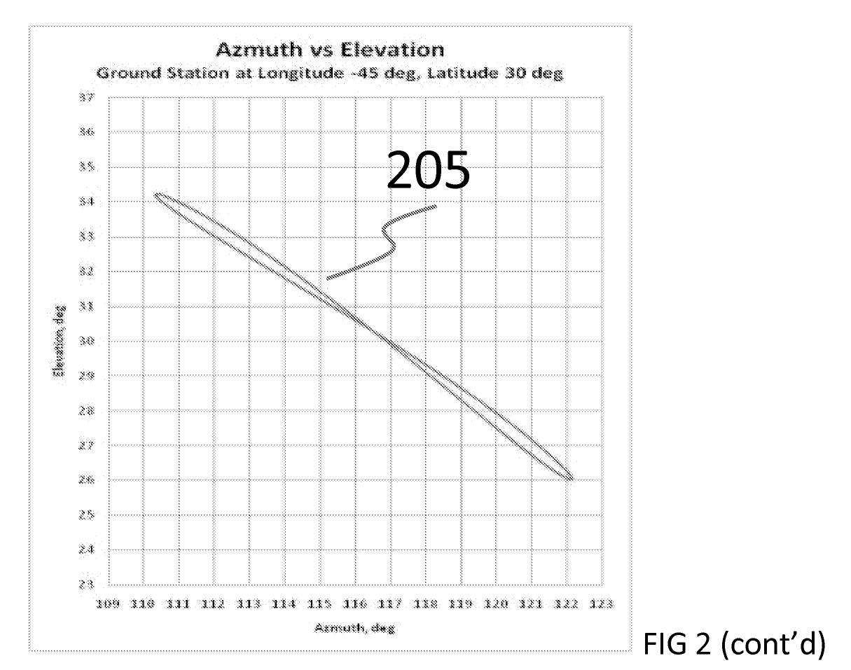

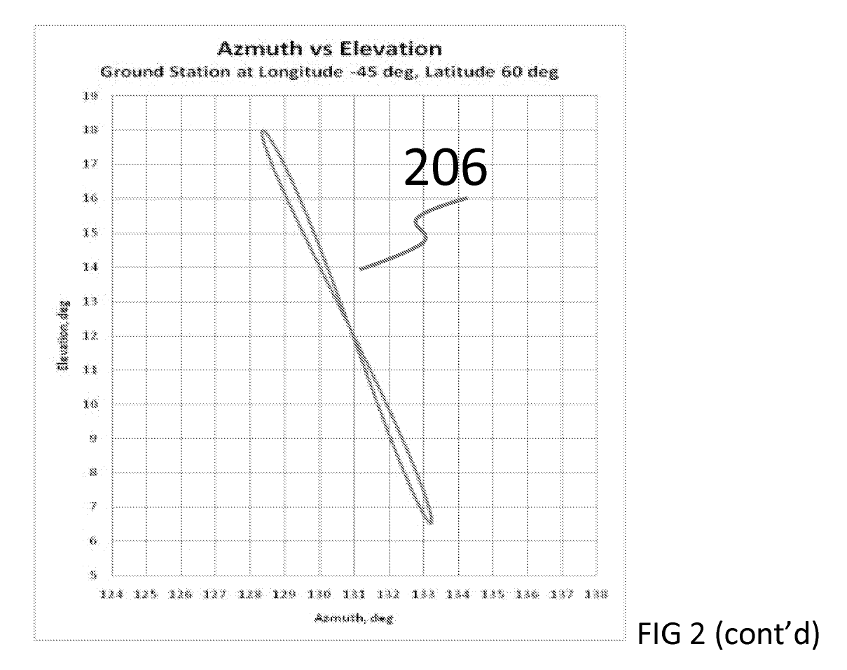

FIG. 2 illustrates the path line of an inclined orbit satellite observed by base stations at different locations on the earth on a daily basis. E.g. The trace line 202 in shape of a slender “8” which has a drift of about 6 degree in the north/south direction and only about 0.2 degree in the east/west direction is observed by a base station at Longitude 0 degree, Latitude 60 degree. Although the observation of the trace line of an inclined orbit satellite varies in different locations, the movement of an inclined orbit satellite remains the same and is repeated every 24 hours due to its geosynchronous characteristics. Therefore, if observed from a fixed location, the direction of an inclined orbit satellite can always be predicted which means an FUT can always form one or multiple dynamic beams to the desired satellites according to their trace line. Similarly, an FUT can also form one or multiple nulls to eliminate interference signals from unwanted inclined orbit satellites by applying appropriate BWV to the antenna array. This technique enables us to place multiple satellites on different inclined orbit by provides the solution to distinguishing signals of designed inclined orbit satellite from other interfering sources.

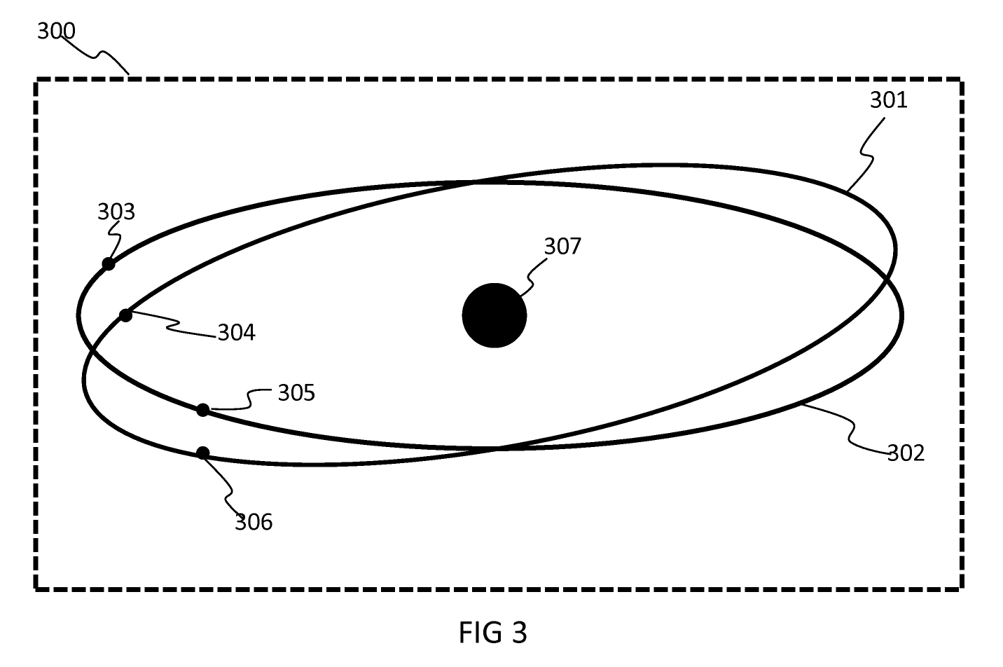

FIG. 3 shows an extreme scenario of inclined orbit satellites operation 300. Two inclined orbit satellites are place in the same slot in different inclined orbits 301 and 302. From t1 to t2, these two satellites move from 303 and 304 to 305 and 306, respectively. Since the inclined orbit is geosynchronous, the relative position of two inclined orbit satellite will be almost unchanged horizontally. However, their relative position in the vertical direction changes periodically. For example, if both satellites have 4.5 degree inclination, both the satellites will move along a trace line which may look like an “8” as shown in FIG. 2 from a ground station. When placed in the same slot, two satellites will move apart from each other and reach the maximum distance of 8 degree and then move close to each other periodically. Twice a day will these satellites get very close in which cases the signal from both satellites can not be identified. However, since the movements of all the inclined orbit satellites are predictable, this problem can be solved through appropriate design of the inclined orbit system.

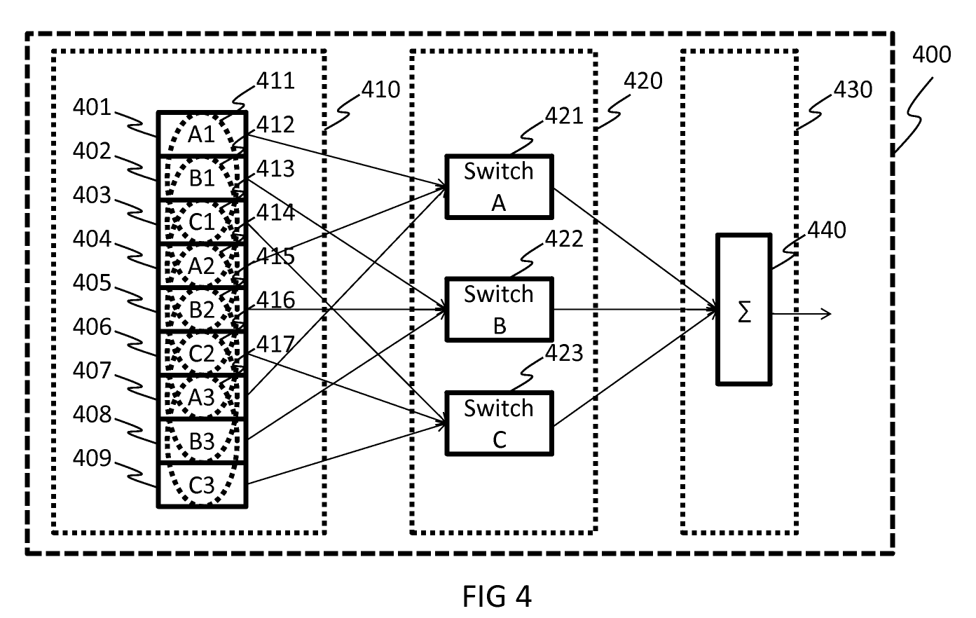

FIG. 4 illustrates the architecture of the horn switching antenna array system 400 which is composed of 3 different parts: an antenna array 410, switches 420 and a signal synthesizer 430. In this embodiment, an antenna array is composed of nine small and over-illuminated antenna elements 401˜409 and every other three elements are connected to a switch which can select and output one of the input signals. Eg. Signals from element A1 401, A2 404, A3 407 are transmitted to the Switch A 421, which can select and transmit either one of them to the signal synthesizer 440 where all the input signals will be summed up. Similarly, Switch B 422 is able to select one signal from B1 402, B2 405 and B3 408 and so forth. By simply selecting different combinations of antenna elements using these switches, different antenna patterns can be achieved at the signal synthesizer. Therefore, we can combine every three contagious adjacent over-illuminate element into one focused element which has a much better secondary pattern. Eg. If Switch A 421, Switch B 422 and Switch C 423 select element A1 401, B1 402, C1 403 respectively, we will get a better focused secondary pattern 411 generated by the combination of three over-illuminated antenna elements. Similarly, we can generate 6 more focused secondary patterns 412-417 by select different antenna elements in this example. Comparing with a traditional focused antenna array 500 which has only 3 different secondary patterns 511, 512, 513 in FIG. 5, the horn switching function provides more selections of beam patterns without increasing physical size of an antenna array. The increase of secondary pattern also reduce the gain drop between peaks of two contiguous secondary patterns, thus greatly improves the scan and tracking ability of an antenna array.

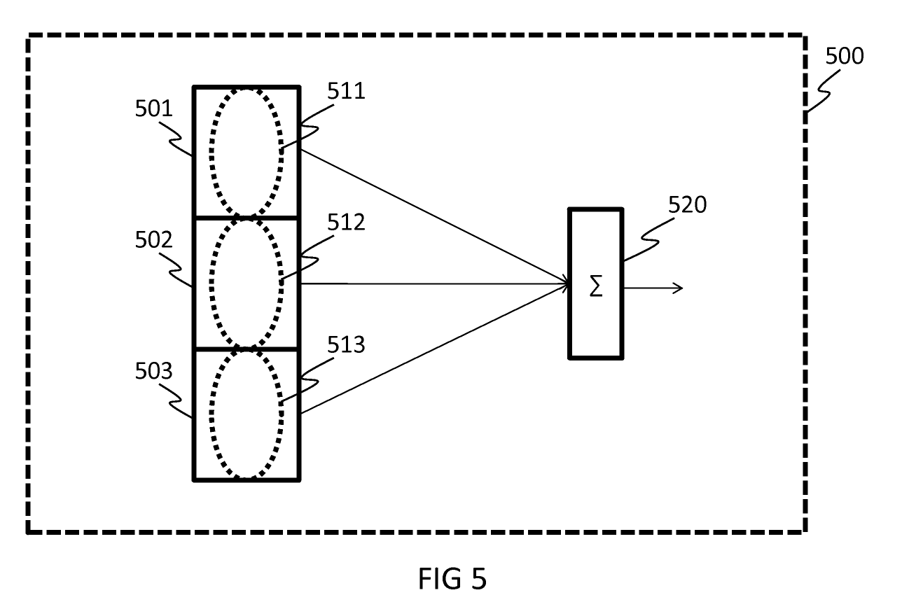

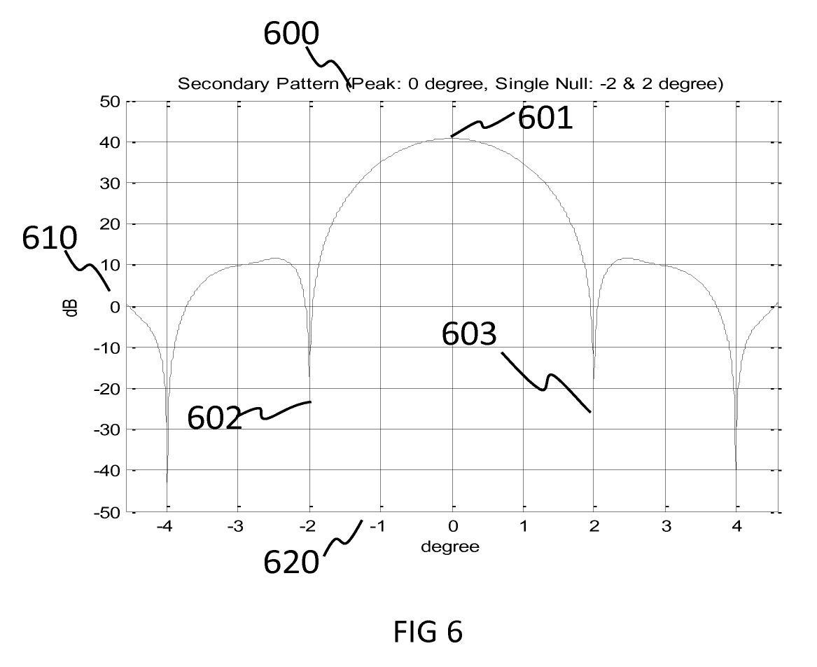

FIG. 6 shows an example of utilizing the digital beam forming technique to communicate with a desired inclined orbit satellite while simultaneously eliminating interfering ones. Since the drift of a trace line of an inclined orbit satellite is very small (less than 0.2 degree) in the east-west direction, the simulation only considers the drift in the north-south direction for simplicity. As shown in FIG. 6, 600 is the secondary pattern of an antenna array with its azimuth axis 610 ranging from −4.56 to 4.56 degree. The vertical axis 620 which represents the intensity of the signal ranges from −50 dB to 50 dB. By using digital beam technique, we form a peak at 0 degree 601 and forming two nulls at −2 and 2 degree 602, 603 respectively to eliminate the interference signal from those directions. However, both nulls are very narrow which require frequent update of BWVs to track the satellites.

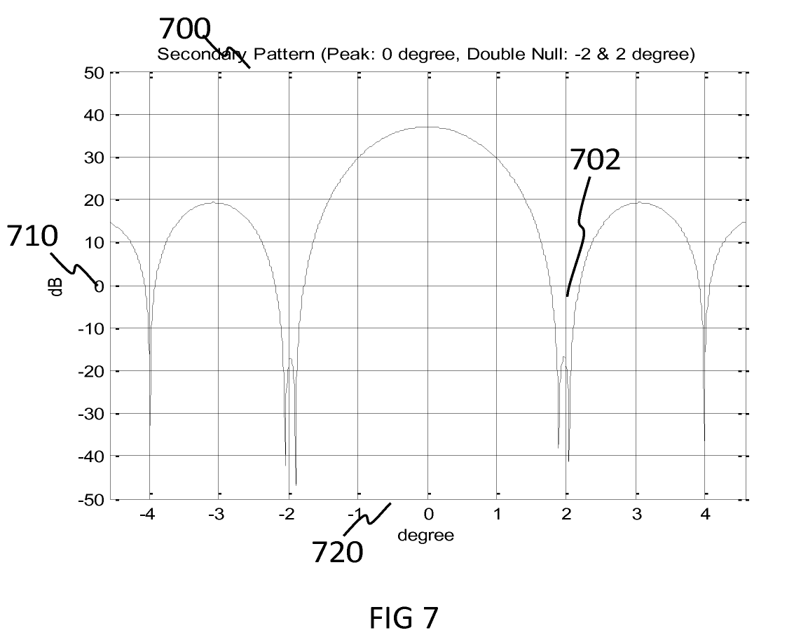

FIG. 7 shows the secondary pattern 700 of an antenna array using double null forming technique. In contrast with the single nulls 601 and 602, 701 and 702 are much wider in their null width. We presume the desired gain suppression of an interfering signal is equal or less than 0 dB. Both 701 and 702 has a null width of about 0.5 degree at 0 dB level. For an inclined orbit satellite with 5 degree inclination, its total movement in 24 hours is about 20 degree. An FUT which forms single null 601 whose null width at −2 degree 602 is about 0.1 degree have to update its BWV every 7.2 minutes. However, An FUT which forms double null with 0.5 degree null width can use the same BWV for about 32 minutes, four times longer than a single null FUT.

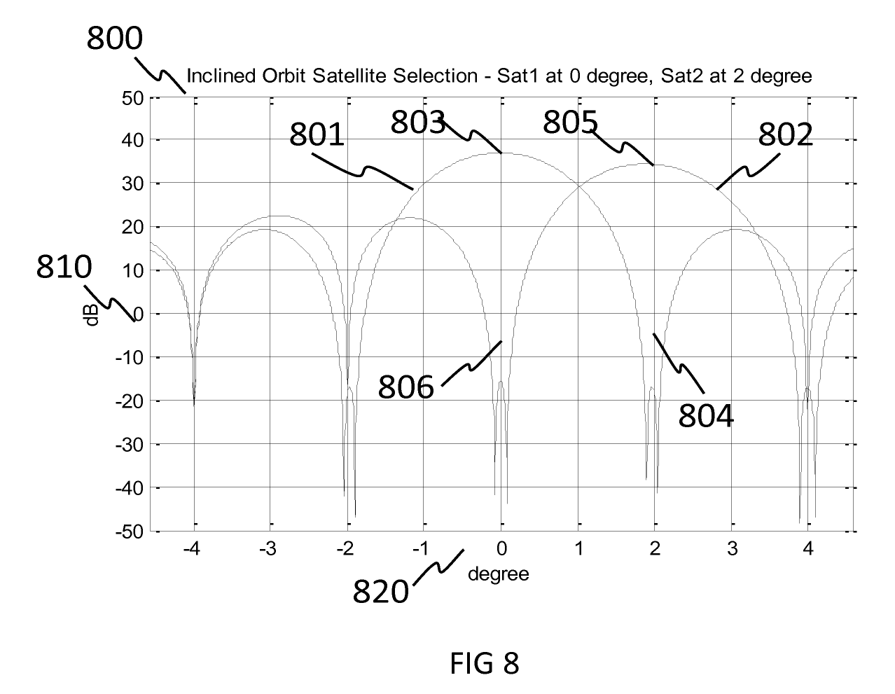

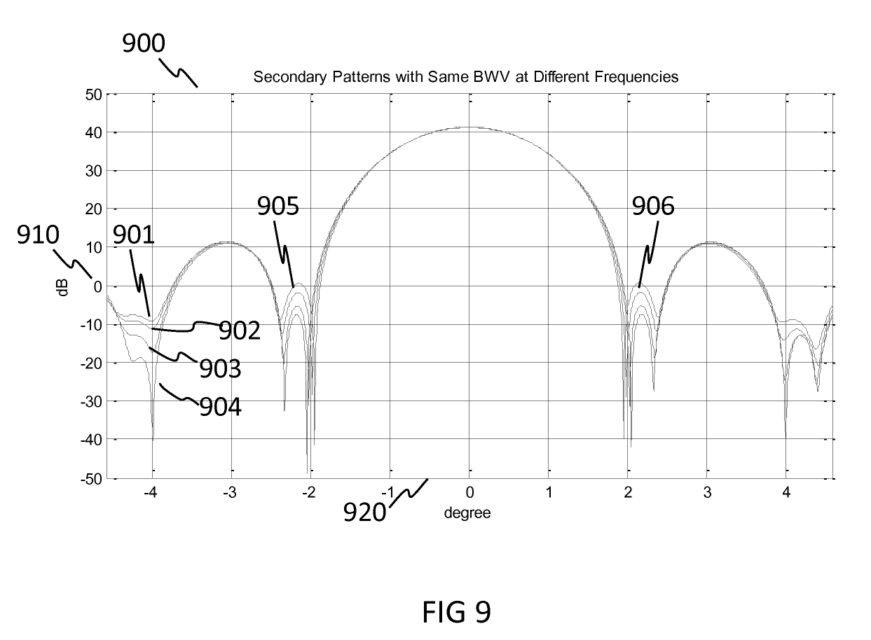

FIG. 8 illustrated a scenario of two incline orbit satellites at 0 and 2 degree respectively 800. Along the horizontal axis 810 is the azimuth ranging from −4.56 to 4.56 degree, and along the vertical axis 820 is the intensity of the secondary pattern ranging from −50 dB to 50 dB. 801 is the secondary pattern of one BWV which forms a peak 803 at 0 degree and a double null 804 at 2 degree. 802 is the secondary pattern using another BWV to form a peak 805 at 2 degree and a double null 806 at 0 degree. A FUT can easily pick one satellite to communicate with while at the same time eliminating the other one. By utilizing double null forming technique, an FUT will have better tolerance to a direction change and frequency of BMV update is also reduced.

Another beneficial effect of double null forming technique is that it enhances the robustness of the secondary pattern to the effect of frequency drift. As depicted in FIGS. 9, 901, 902, 903 and 904 are secondary patterns using the same BWV at 19.95 GHz, 20.00 GHz, 20.10 GHz and 20.20 GHz respectively. However, by utilizing double null forming technique, the null width of 905 and 905 is still greater than 0.5 degree at 0 dB level which provide which provide a tolerance of frequency drift by 250 MHz in this example. The frequency drift tolerance enhance by using double null forming technique has its limitation. However, this problem can be also solved by using a band pass FIR filter.

What is claimed is:

1. A mechanically fixed ground user terminal transceiver which is capable of performing a one-dimensional electronic scan and tracking with a range from −15 to +15 degrees, with the present fixed user terminal comprising:
an antenna array composed of a plurality of antenna elements;
at least one low noise amplifier and one frequency down converter connected to the plurality of antenna elements and adapted to down-convert the signals from the plurality of antenna elements to at least one of an intermediate frequency and baseband frequency;
a memory element adapted to store calibration data comprising beam weighting vectors associated with plurality of said antenna elements;
a digital beam forming (DBF) processor adapted to process the frequency down-converted signals from the plurality of antenna elements, wherein the DBF processor is further adapted to:
apply the beam weighting vectors to the frequency down-converted signals,
selectively combine one or some of the weighted down-converted signals,
create at least one coherent beam from the combination of the weighted down converted signals;
an array processor adapted to control the DBF which processes the down-converted signals from the plurality of antenna elements, wherein the array processor is further adapted to:
dynamically assign one or some of multiple array elements to form at least on beam
dynamically alter the beam weighting vectors (BWVs) to change a pointing direction of the at least one coherent beam for tracking at least one of the plurality of GPS satellites.

2. The FUT transceiver of claim 1, wherein the plurality of said antenna elements is configured as an array that is distributed across a planar surface.

3. The FUT transceiver of claim 1, wherein the plurality of said antenna elements is configured as an array that is not contained within a single plane.

4. The FUT transceiver of claim 1, wherein at least one coherent beam created by DBF processor under the control of the array processor comprises a single beam that is dynamically formed from a combination of all the plurality of antenna elements to track, receiving signals from, transmit signals to, or bi-directionally communicate with an inclined orbit satellite.

5. The FUT transceiver of claim 1, wherein at least one coherent beam created by DBF processor under the control of the array processor comprises multiple beams that is dynamically formed from a combination of all the plurality of antenna elements to track, receiving signals from, transmit signals to, or bi-directionally communicate with multiple inclined orbit satellite.

6. The FUT transceiver of claim 1, wherein at least one coherent beam created by DBF processor under the control of the array processor comprises directional gain suppression in one direction from a combination of all the plurality of antenna elements to track and eliminate signals from an inclined orbit satellite.

7. The FUT transceiver of claim 1, wherein at least one coherent beam created by DBF processor under the control of the array processor comprises directional gain suppression in multiple directions from a combination of all the plurality of antenna elements to track and eliminate signals from multiple inclined orbit satellite.

8. The FUT transceiver of claim 1, wherein at least one coherent beam created by DBF processor under the control of the array processor comprises directional gain and suppression in one or multiple directions from a combination of all the plurality of antenna elements to track, receive signal from, transmit signals to, bi-directional communicate with or eliminate signals from multiple inclined orbit satellites simultaneously.

9. The FUT transceiver of claim 1, wherein at least one coherent beam created by DBF processor under the control of the array processor comprises at least one double null from a combination of all the plurality of antenna elements to increase the null width, thus increase the null's robustness to direction and frequency drift.

10. A mechanically fixed ground user terminal transceiver which is capable of performing one-dimensional electronic scan and tracking with a range from −15 to +15 degree. The present fixed user terminal comprising:
an antenna array composed of a plurality of antenna elements
at least one low noise amplifier and one frequency down converter connected to the plurality of antenna elements and adapted to down-convert the signals from the plurality of antenna elements to at least one of an intermediate frequency and baseband frequency;
N switches that select signals from antenna elements to provide multiple combination of N over-illuminated antenna elements into one focused antenna array with certain maneuver:
the 1^{st} and every other Nth element transmit signal to the 1^{st} switch, and
the 2^{nd} and every other Nth element transmit signal to the 2^{nd} switch and so forth. Until all the elements are assigned to N switches;
A signal synthesizer to sum up all the signals transmitted from all the switches to perform one dimensional limit scan by selecting different combination of signals from antenna elements.
